(19) United States
(12) Patent Application Publication
(10) Pub. No.: US 2005/0205562 A1
(43) Pub. Date: Sep. 22, 2005

(54) Heating device

(76) Inventor: Ulf Thelander, Storgatan (SE)

Correspondence Address: Norman P Soloway;Hayes Soloway Hennessey Grossman & Hage, 175 Canal Street, Manchester, NH, 03101, US

(21) Appl. No.: 10/516,869

(22) PCT Filed: Jun. 3, 2003
(86) PCT No.: PCT/SE03/00906

§ 371 Date: Jan. 3, 2005

(30) Foreign Application Priority Data
Jun. 5, 2002 (SE) 0201712-7

(51) Int. Cl. H05B 6/10

(52) U.S. Cl. 219/642

(57) ABSTRACT

Device for induction heating of ring-shaped objects, including a magnetizable core with one or several coils, which core has a moveable part that is displaceable, for insertion through the ring-shaped object that is to be heated. The object that is to be heated rests on rails or bars on which the object can slide electrically and thermally insulated. The device is inclined laterally so that the objects that are to be heated can slide in to and/or out from the heating position.

This invention concerns a heating device where the heating is carried out by means of induction. In particular the invention has as its object an induction heating that can be used in the connection with hardening; and then in particular to harden rapidly hardening steel that hardens in air. To heat objects by means of induction is in itself well known, but at heating for hardening the demands on the heating device are far greater when it comes to the achieving of a uniform temperature in the objects that are to be hardened. If the temperature is not uniform objects of some types of steel that are to be hardened undergo a change of shape during the heating, which then remain after the cooling, this is in particular the case for a new air hardening steel. Furthermore the hardness may vary if the temperature is non-uniform. Since at hardening of for instance the above new type of steel the temperatures used at hardening are very high the steel will be very plastic and easily deformed and the object or objects that are to be hardened must therefor be handled very gentle.

In view of the above problems the object of the invention is to achieve an induction heating that works very fast, efficiently, uniformly and that furthermore is very gentle to the objects that are to be heated.

In accordance with the invention this object is solved by placing the object that is to be heated in an opening in a C-shaped main core supported on a pole piece. Through the object that is to be heated, in particular rotationally symmetrically ones, a moveable core connection is arranged extending straight through this object so that the core is closed. The object that is to be heated, the core and a coil arranged around this constitute principally a transformer where current is induced in the object that is to be heated. By selecting the amperage in the coil the energy generation in the object that is to be heated is also controlled. Since the current in the object is distributed over its cross section the heating will become very uniform. By letting the object that is to be heated rest on distance means of for instance aluminum oxide transfer of heat energy from the heated object to the core is eliminated.

The part of the core that extends through the object that is to be heated extends either to the opposite pole piece of the core to contact with this through recesses in the insulating distance means or is provided with recesses corresponding to the insulating means. The insulating means may either be constituted by an entire surface with one or several recesses for the contact of the pole piece through this coating alternatively one can consider the insulating means being constituted by protruding bars or rails on which the object that is to be heated rests. Recesses are either arranged in the rails for the opposed moveable central core part alternatively groves are shaped in the downwards facing surface of this in contact with the lower pole piece.

Through the above measure not only an electric insulation of the object that is to be heated is achieved that prevent induced current from leaking, but also heat is prevented from leaking over to the core. In his way the heat will become uniform through the object on its upper side as well as on bottom side and the risk of deformation and non-uniform hardening are eliminated respectively. Through the reduction of the heat loss also the strains of the core are reduced as well as the heat loss to this. In order further to reduce the heat losses to core and pole pieces the surfaces of these that are facing the object that is to be heated may be polished so that the heat radiation is reflected.

The objects that are to be heated are heated piece by piece and rests during the heating on the thermally and electrically insulating support. Through the use of rail or bar like means the contact surface is also reduced and thereby the possible heat transfer.

If so desired also the core part that extends through the object that is to be heated may be provided with bars and a surface coating of electrically and thermally insulating material to prevent contact between the core and the heated object.

In order to secure a gentle handling of the objects that are to be heated the core and the support surface respectively of the object that is to be heated are in a further development of the invention arranged inclined. In this way the object that is to be heated can when the heating has taken place to a sufficient temperature be released, then to slide away from the place of heating influenced by its own weight to the next treatment step. The angle of inclination is chosen so that the object that is to be heated by its own weight slide on the bars.

Further advantages and characteristics of advantageous further developments of the inventive thought are apparent from the patent claims and the following description of a preferred embodiment with reference to the enclosed drawings. In the drawings

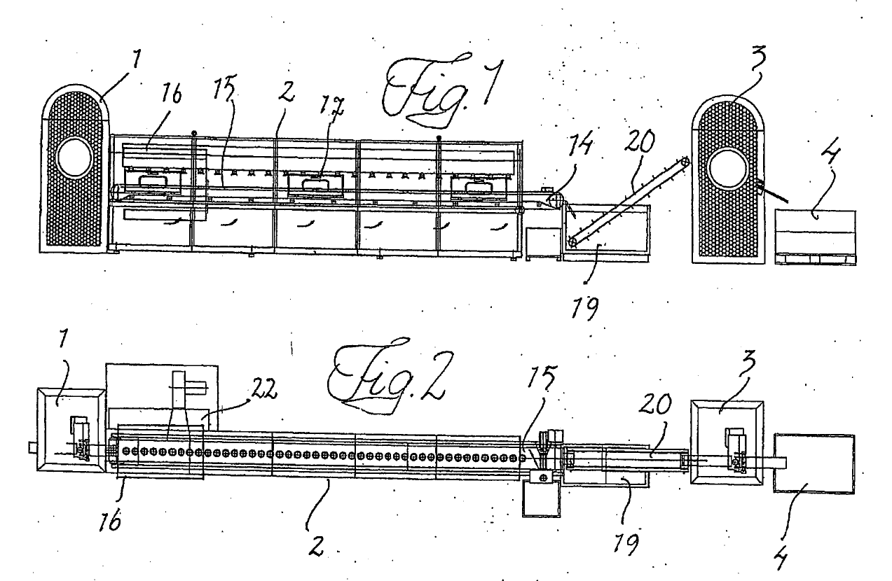

FIG. 1 schematically show an installation in accordance with the invention seen from the side,

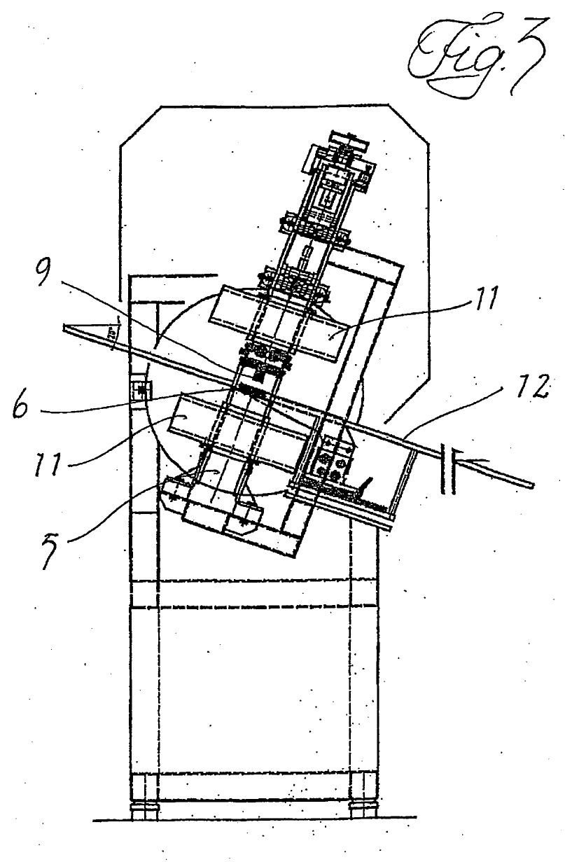

FIG. 2 the installation seen from above,

FIG. 3 the heating device in itself seen from the side,

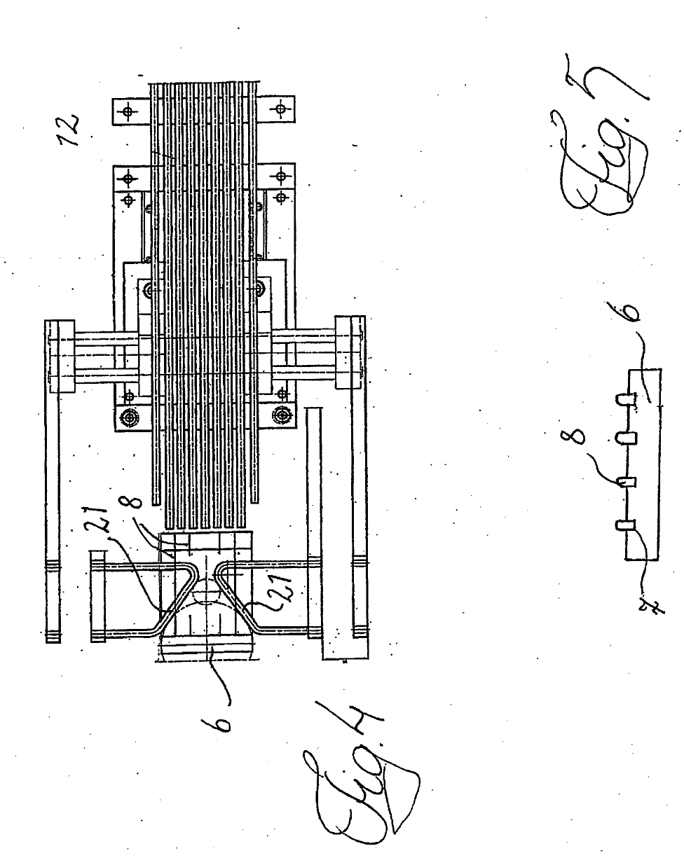

FIG. 4 a detail of the heating device and

FIG. 5 a cross section through the lower pole piece.

The installation for hardening of for instance ball bearing and roller bearing races include a first heating module 1, a following air cooling module 2 and thereafter a tempering module with following cooling tub 4.

The heating module includes a principally C-shaped core that is inclined 20 degrees, The lower part in the opening in the core is provided with an exchangeable pole piece 6 that in principle has the shape of a plate. In the plate grooves 7 are cut and in these bars of aluminum oxide are received that protrude a few millimeters over the surface of the pole piece. In the opposite part of the core an upper pole piece is constituted of a central cylindrical displaceable core part 9 so arranged that it can be displaced down to contact with the lower pole piece 6 and respectively be lifted from this a sufficient distance to allow the bearing rings that are to be hardened to pass between the pole pieces. This displacement of the displaceable core part 9 takes place by means of a motor arranged in the upper end of the core and furthermore a locking device is arranged to fix the moveable cylindrical pole piece part against the core when heating is carried out, in order to close the magnetic field and reduce the vibration risk. On the core furthermore two coils 10, 11 are arranged. The inclined lower pole piece plane is extended with an inclined plane constituted of stainless bars 13 extending in the direction of movement of the heated bearing rings down to a belt conveyor 14.

The transporting surface 15 of the belt conveyor is made of stainless helixes which at the same time as a satisfactory supporting surface provide a minimal heat transfer and pressure influence. The conveyor 14 extends closest to the heating module through a heat trap constituted of a water cooled jacket 16 that is painted black or coated with some other heat absorption promoting material. From this the conveyor runs through an air cooling section where air is blown through with the object to cool the heated goods. The air and water cooled sections can also if so desired be arranged overlapping that is one may have air channels through the water cooled jacket. Since the conveyor is constituted by stainless helixes also a good air transport is enabled straight through this and the bearings that are to be cooled. The air is recirculated in the air cooling section and is fed through so called iris valves 17 that independent of the degree of throttling provide the same shape of the flow. The air is cooled with a water cooled cooling core.

After the air cooling section a check control station 18 follow where a heat camera reads the temperature of the bearing rings. If the temperature is too low this indicates that the heating has failed and the ring is pushed off from the band laterally. If three consecutive rings are too cold the feed of rings to the heating device is stopped for checking and possible attending. One can proceed in the same way with too hot rings.

The belt conveyor 14 finally deliver the air hardened rings that then have a temperature of 75 to 100° C. in a tub 19 filled with water for final cooling to room temperature or below this for completing of the hardening. Since the temperature before the water bath is that low one does not risk that the rings cracks or crackles. From the tub 19 the rings are transported up with a belt conveyor 20 and are fed to the heat device 3 for tempering heating that to its general build coincide with the first heating device and from this heating device the bearing rings are after intended heating once again dropped into a water filled tub 4 for cooling, wherefrom they are then transported away for further machining, that is in particular grinding.

The above described heating device works in such a manner that when heating is to take place the upper circular pole piece 9 is pulled up and a bearing ring is by means of a robot placed on the lower pole piece 6 lying on the bars 8 of aluminum oxide on this. The bearing ring slides after being released by the robot down towards two obliquely arranged bars 21 of stainless steel that extend inward from each side. These bars are electrically insulated from the surrounding but connected to a separate current source and immediately when a bearing ring is in contact with both of the oblique bars an electric contact is established and a current flows through the bars and the ring, which is used as an indication that the ring is in position.

When the bearing ring is in position the upper circular pole piece 9 is then displaced downwards to contact with the lower pole piece 6. The bars 8 are left out in the contact area with the lower pole piece. The upper pole piece is then locked against the main core and current is fed to the coils 11 inducing a powerful current in the bearing ring that in a few seconds reach the required hardening interval of the temperature. At this the bearing ring expands giving a small movement in relation to the stainless bars 20, 21, which movement also gives a small abrasion ensuring electric contact. If so is desired one can also consider allowing a vibrator to vibrate the bars slightly in order to increase the abrasion and thereby improve the electric contact. Furthermore the vibration may facilitate a possible required lateral movement at an uncentered placing of the bearing rings.

The temperature of the bearing rings is monitored by means of a heat camera for possible adaption of current and feed tine of the current through the coil.

When the temperature level has been achieved slightly above the lower limit of hardening the current to the coil is interrupted, the upper pole piece is released and lifted by its associated motor 22. Thereafter the heated bearing ring is released by the oblique stainless bars being pulled apart laterally and the bearing ring slides on the aluminum oxide bars to the conveyor.

By controlling the lateral movements of the two stainless bars 20, 21 the rings may be spread somewhat over the width of the conveyor so that the rings end up further from each other and thereby reduce the risk of mutual heat influence, that otherwise at too closely placed rings may lead to a non-uniform cooling process with slower cooling of the parts of the rings that are close to each other.

After the gentle landing of the bearing rings on the conveyor 14 these enter the area of the water cooled jacket 16. The powerful heat radiation from the bearing rings is absorbed by the jacket and heats the cooling water in this and a reduced amount of the heat that is radiated out towards the jacket is reflected back towards the rings that thereby can emit heat in about the same rate as if they should be entirely free from reflecting environment. The jacket thus makes it possible with efficient cooling in a small space. Also the following air cooling is efficient since the air is water cooled in a cooler 22, for instance with the same circulating water that is used in the water cooled jacket. Through a fast air exchange also in this a fast, efficient and uniform further cooling is achieved.

Also in the following tub for water cooling of the bearing rings the same cooling water may be used and this may also be used after the tempering if so desired. The cooling water circulates after use to a not shown cooling device where the temperature is lowered, whereafter the cooling water is reused.

The water cooled jacket 16 is located closest to the heating device 1 since the heat emitted as radiation is as largest when the rings are the hottest.

In order to make it easier for the rings to slide down from their place at the heating down towards the conveyor a nozzle for pressurized air or two may be arranged on the upper side of these so that an impact of pressurized air can help to start the rings. In this way the angle of inclination of the core and the plane on which the rings slide respectively can be changed, thereby reducing the risk that for instance higher rings fall over on the conveyor.

For the adaption to bearing rings with different height and diameter respectively the pole pieces (flat and circular part) when needed can easily be changed, which further is facilitated by the heating of the pole pieces being very small. In comparison with known hardening methods the hardening according to the invention may in a quite different way be inserted into a production line, at which also very quick changes between different dimensions are possible.

Advantageously the heating in he heating stations is monitored with heat cameras.

The invention thus enables fast and efficient handling of the hardening, in particular of the new air hardening steel since this need not to be kept hot for a long time but is restructured fast when the correct temperature interval has been reached, which temperature interval is comparatively broad. Since the heating can take place uniformly without harmful influence on for instance the bottom of the rings a good degree of uniformity is obtained in each ring as well as from ring to ring. Since the steel in question swell somewhat at hardening a possible lower temperature on the bottom side would easily result in a slight cone shape. Since this can be avoided a very good precision and symmetry can be obtained for ready bearing rings, which in turn means that the amount of following grinding work or rather die amount of material that has to be ground away can be reduced, improving the economy in the manufacture.

Since the heating is effected electrically and the cooling with recirculating water and recirculating air that in turn is cooled by the water a very environmental friendly installation is achieved that does not emit any pollution to the environment. Since the installation is so “clean” it can be located in direct connection to the rest of the machines for machining without inconveniences for these. Since the installation without disadvantage can be built in and be enclosed by panels respectively it will furthermore be very silent.

1. Device for induction heating of ring shaped objects, wherein
a magnetizable core with one or several coils, which core has a moveable part that is displaceable, for the inserting through the ring shaped object that is to be heated, the object to be heated resting on a support that is electrically and thermally insulating.

2. Device according to claim 1, wherein
the support that is electric and thermally insulating and support the object that is to be heated comprise rails or bars on which the object can slide.

3. Device according to claim 1, wherein
the bars have recesses or are left out where the part of the core that extends through the object that is to be heated can be brought in contact with the underlying pole piece.

4. Device according to claim 2, wherein
recesses are arranged in the moveable core part so that these can grip over the slide rails and come in contact with the underlying pole piece.

5. Device according to claim 1, wherein
it is inclined laterally so that objects that are to be heated can slide in to and/or out from the heating position.

6. Device according to claim 1, wherein
the object that is to be heated is held in place by two angled rods.

7. Device according to claim 6, wherein
the angled bars are insulated from the surroundings but mutually in contact with an electric sensor that can sense when the objects that are to be heated give an electric contact between the two angled bars.

8. Device according to claim 7, wherein
the rods are of stainless steel and are brought to vibrate slightly.

9. Device according to claim 1, wherein
the preheated objects after the heating is fed through a space that is surrounded by a water cooled jacket for the draining of heat.

10. Device according to claim 1, wherein
a nozzle for pressurized air is arranged to blow air towards the heated object when this is to be moved from the heating location.
